(19) United States
(12) Patent Application Publication
(10) Pub. No.: US 2024/0177214 A1
(43) Pub. Date: May 30, 2024

(54) COMPUTING DEVICE AND OPERATING METHOD THEREOF

(71) Applicant: SAMSUNG ELECTRONICS CO., LTD., Suwon-si (KR)

(72) Inventors: Kwanki AHN, Suwon-si (KR); Saeeun CHOI, Suwon-si (KR)

(73) Assignee: SAMSUNG ELECTRONICS CO., LTD., Suwon-si (KR)

(21) Appl. No.: 18/383,772

(22) Filed: Oct. 25, 2023

Related U.S. Application Data
(63) Continuation of application No. PCT/KR2023/016155, filed on Oct. 18, 2023.

(30) Foreign Application Priority Data
Nov. 25, 2022 (KR) 10-2022-0160793

(51) Int. Cl. G06Q 30/0601

(52) U.S. Cl. CPC G06Q 30/0631

(57) ABSTRACT

A computing device obtains first metadata information related to a plurality of items of content and content viewing history information related to a user, generates a first feature vector for the user based on second metadata information related to at least one item of content viewed by the user in the content viewing history information related to the user, generates a plurality of second feature vectors, each of the plurality of second feature vectors corresponding to one of the plurality of items of content based on the first metadata information related to the plurality of items of content, and generate a recommendation including at least one item of content to the user, among the plurality of items of content, based on a result of a comparison between first feature vector for the user and the plurality of second feature vectors of the plurality of items of content.

### CROSS-REFERENCE TO RELATED APPLICATION(S)

This application is a bypass continuation of International Application No. PCT/KR2023/016155, filed on Oct. 18, 2023, which is based on and claims priority to Korean Patent Application No. 10-2022-0160793, filed on Nov. 25, 2022, in the Korean Intellectual Property Office, the disclosures of which are incorporated by reference herein in their entireties.

### BACKGROUND

### 1. Field

The disclosure relates to a computing device and an operating method of the computing device, and in particularly, a computing device for recommending content suitable for a user based on a content viewing history of the user, and an operating method of the computing device.

### 2. Description of Related Art

A recommendation system is a system that recommends movies, content, or items to users. Internet shopping sites such as Amazon® or online video content providing sites such as Netflix® may recommend new content to a user based on a consumption history of the user, such as a product purchase history, a viewing history, or ratings, and consumption histories of other users.

Artificial intelligence is a computer system for implementing human-level intelligence, in which a machine learns, makes decisions, and obtains a higher recognition rate the more the system is used. Artificial intelligence technology includes machine-learning (e.g., deep-learning) technology that uses an algorithm for classifying/learning features of input data, and element technologies for copying cognition and decision functions of the human brain through a machine-learning algorithm.

Methods of recommending content using artificial intelligence technology may be less useful until a sufficient amount of viewing history data of a corresponding user for learning is collected.

### SUMMARY

According to an aspect of the disclosure, there is provided an apparatus including: a memory storing one or more instructions; and at least one processor configured to execute the one or more instructions stored in the memory to: obtain first metadata information related to a plurality of items of content; obtain content viewing history information related to a user; generate a first feature vector for the user based on second metadata information related to at least one item of content viewed by the user in the content viewing history information related to the user; generate a plurality of second feature vectors, each of the plurality of second feature vectors corresponding to one of the plurality of items of content based on the first metadata information related to the plurality of items of content; compare the first feature vector for the user with the plurality of second feature vectors of the plurality of items of content; and generate a recommendation information including at least one item of content to the user, among the plurality of items of content, based on a result of the comparison between first feature vector for the user and the plurality of second feature vectors of the plurality of items of content.

According to another aspect of the disclosure, there is provided a method of operating an apparatus, the method including: obtaining first metadata information related to a plurality of items of content; obtaining content viewing history information related to a user; generating a first feature vector for the user based on second metadata information related to at least one item of content viewed by the user in the content viewing history information related to the user; generating a plurality of second feature vectors, each of the plurality of second feature vectors corresponding to one of the plurality of items of content based on the first metadata information related to the plurality of items of content; comparing the first feature vector for the user with the plurality of second feature vectors of the plurality of items of content; and generating a recommendation information including at least one item of content to the user, among the plurality of items of content, based on a result of the comparison between first feature vector for the user and the plurality of second feature vectors of the plurality of items of content.

According to another aspect of the disclosure, there is provided a computer-readable recording medium having recorded thereon a program for executing an operation on a computer, the operation including: obtaining first metadata information related to a plurality of items of content; obtaining content viewing history information related to a user; generating a first feature vector for the user based on second metadata information related to at least one item of content viewed by the user in the content viewing history information related to the user; generating a plurality of second feature vectors, each of the plurality of second feature vectors corresponding to one of the plurality of items of content based on the first metadata information related to the plurality of items of content; comparing the first feature vector for the user with the plurality of second feature vectors of the plurality of items of content; and generating a recommendation information including at least one item of content to the user, among the plurality of items of content, based on a result of the comparison between first feature vector for the user and the plurality of second feature vectors of the plurality of items of content.

### BRIEF DESCRIPTION OF DRAWINGS

Embodiments will be more clearly understood from the following detailed description taken in conjunction with the accompanying drawings in which:

FIG. 1 is a diagram illustrating a process in which a computing device recommends content based on a viewing history of a user, according to an embodiment of the disclosure.

FIG. 2 is a block diagram of a configuration of a computing device according to an embodiment of the disclosure.

FIG. 3 is a block diagram of a detailed configuration of a computing device according to an embodiment of the disclosure.

FIG. 4A is a flowchart illustrating an operating method of a computing device according to an embodiment of the disclosure.

FIG. 4B is a flowchart illustrating an operating method of a computing device according to an embodiment of the disclosure.

FIG. 5 is a flowchart illustrating an operating method of a computing device according to an embodiment of the disclosure.

FIG. 6 is a diagram illustrating an example of a content viewing history of a user and metadata information about content viewed by the user, which are obtained by a computing device, according to an embodiment of the disclosure.

FIG. 7 is a diagram for describing a process of defining a feature vector for a genre among pieces of metadata information about content, according to an embodiment of the disclosure.

FIG. 8 is a diagram for obtaining a user feature for a genre among pieces of metadata information about content included in a user viewing history to generate a feature vector for the user, according to an embodiment of the disclosure.

FIG. 9A is a diagram illustrating an example of a method of generating a feature vector for a user, according to an embodiment of the disclosure.

FIG. 9B is a diagram illustrating an example of a method of generating a feature vector for each of a plurality of item of content, according to an embodiment of the disclosure.

FIG. 10 is a diagram illustrating an example of a method of generating a feature vector for a user, according to an embodiment of the disclosure.

FIG. 11 is a diagram illustrating an example of a method of normalizing a user feature and assigning a weight to the user feature for a genre of content, according to an embodiment of the disclosure.

FIG. 12 is a diagram illustrating an example of a method of comparing a feature vector for a user with a feature vector for each item of content, according to an embodiment of the disclosure.

FIG. 13 is a diagram illustrating an example of a result of calculating a recommendation score for each item of content based on obtained content viewing histories of users, according to an embodiment of the disclosure.

FIG. 14 is a flowchart illustrating an operating method of a computing device for recommending content based on two features of metadata information about content, according to an embodiment of the disclosure.

FIG. 15 is a diagram illustrating an example in which a computing device recommends content based on two features of metadata information about content, according to an embodiment of the disclosure.

### DETAILED DESCRIPTION

Embodiments of the disclosure will now be described more fully hereinafter with reference to the accompanying drawings so that it may be easily implemented by those of ordinary skill in the art. However, the disclosure may have different forms and should not be construed as being limited to the embodiment set forth herein.

Terms used herein are general terms currently widely used in the art based on functions described in the disclosure, but may have different meanings according to an intention of one of ordinary skill in the art, precedent cases, or advent of new technologies. Thus, the terms used herein should be construed not based on simple appellations thereof but based on the meaning of the terms together with the overall description of the disclosure.

Throughout the disclosure, the expression “at least one of a, b or c” indicates only a, only b, only c, both a and b, both a and c, both b and c, all of a, b, and c, or variations thereof.

In addition, the terms used herein are only used to describe a particular embodiment of the disclosure for illustration, and are not intended to limit the disclosure.

Throughout the specification, when a component is referred to as being “connected” or “coupled” to another component, it may be directly connected or coupled to the other component, or may be electrically connected or coupled to the other component with intervening components therebetween.

The use of the terms “the” and similar referents in the context of describing the disclosure (especially in the context of the following claims) are to be construed to cover both the singular and the plural. Also, the steps of all methods described herein may be performed in any suitable order unless otherwise indicated herein or otherwise clearly contradicted by context. The disclosure is not limited to the described order of the operations.

Thus, the expression “according to an embodiment” or “in an embodiment” used in the entire disclosure does not necessarily indicate the same embodiment.

Some embodiments of the disclosure may be described in terms of functional block components and various processing operations. Some or all of such functional blocks may be implemented by any number of hardware and/or software components that perform specific functions. For example, functional blocks according to the disclosure may be realized by one or more microprocessors or by circuit components for a certain function. Furthermore, functional blocks according to the disclosure may be implemented with any programming or scripting language. The functional blocks may be implemented using various algorithms executed on one or more processors. Furthermore, the disclosure may employ techniques of the related art for electronics configuration, signal processing and/or data processing. The terms “mechanism”, “element”, “means”, and “configuration” are used broadly and are not limited to mechanical or physical configurations.

Furthermore, connecting lines or connectors shown in various figures are intended to represent exemplary functional relationships and/or physical or logical couplings between components in the figures. In an actual device, connections between components may be represented by alternative or additional functional relationships, physical connections, or logical connections.

In addition, terms such as “ . . . or/er”, “ . . . module”, or the like refer to units that perform at least one function or operation, and the units may be implemented as hardware or software or as a combination of hardware and software.

Also, the term “user” used herein refers to a person who controls a function or an operation of a computing device by using the computing device, and may include a viewer, a manager, or an installation engineer.

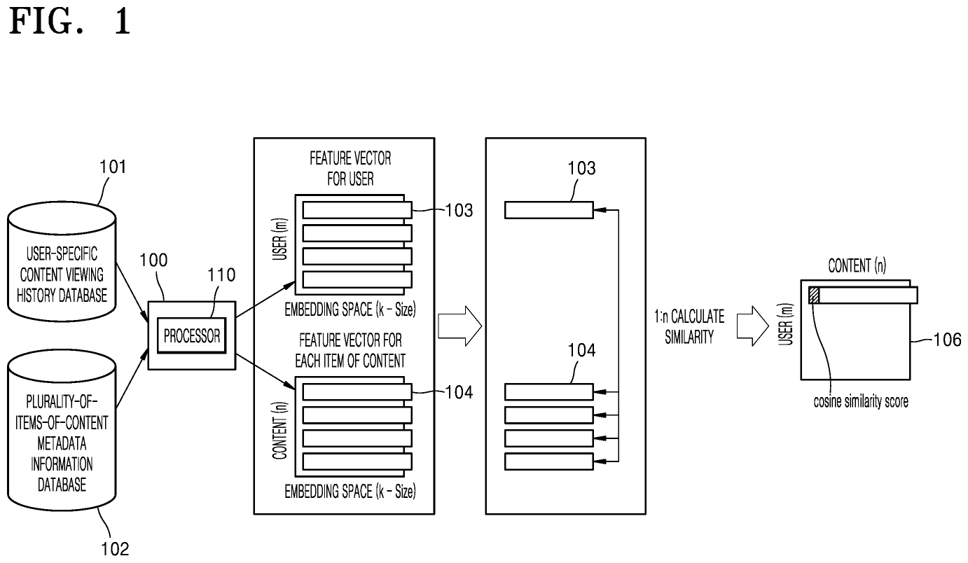

FIG. 1 is a diagram illustrating a process in which a computing device recommends content based on a viewing history of a user, according to an embodiment of the disclosure.

According to an embodiment of the disclosure, a computing device 100 may be implemented in various forms. For example, the computing device may be a smart television (TV), a mobile device, a smart phone, a tablet personal computer (PC), a laptop computer, a desktop computer, a netbook computer, a personal digital assistance (PDA), a portable multimedia player (PMP), a digital camera, a camcorder, a navigation device, a MP3 player, an electronic book reader, a digital broadcast terminal, a wearable device, or an electronic book.

The computing device 100 is not limited thereto and may be implemented as any type of electronic device including a processor 110 and a memory.

For example, the embodiments of the disclosure may be implemented in a display device through which a user may view content, including a large video outputter, such as a smart TV, but is not limited thereto. Also, the computing device 100 may be a fixed type or a mobile type and may include a digital broadcasting receiver that may receive digital broadcasting.

In an embodiment of the disclosure, the computing device 100 may obtain a content viewing history of a user from a user-specific content viewing history database 101 storing a content viewing history of each user.

In an embodiment of the disclosure, the computing device 100 may identify a user by using various user identification methods. For example, the computing device 100 may identify the user based on login information (e.g., user logging into an application for content viewing), fingerprint recognition, face recognition, or speech recognition. The computing device 100 may obtain a content viewing history of the identified user from the user-specific content viewing history database 101.

In the embodiment of FIG. 1, it has been illustrated that the user-specific content viewing history database 101 is separately external to the computing device 100. However, the disclosure is not limited thereto, and as such, the user-specific content viewing history database 101 may be part of the computing device 100 or may be present inside the computing device 100.

In an embodiment of the disclosure, the computing device 100 may obtain, from a plurality-of-items-of-content metadata information database 102 storing metadata information about a plurality of items of content, a plurality of items of content viewable by a user and metadata information about the plurality of items of content.

According to an embodiment of the disclosure, the “plurality of items of content” may refer to all items of content viewable by a user. However, the disclosure is not limited thereto.

According to an embodiment of the disclosure, the “metadata information” refers to information representing content. For example, the metadata information may include descriptive metadata information that is irrelevant to the substance of the content but expresses how the content was created, such as a production company, director, running time, or actor/actress (cast), and semantic metadata information related to the substance of the content itself, such as a title, plot, rating, or genre. That is, the metadata information may be information representing features of the content. However, the disclosure is not limited thereto, and as such, according to another embodiment, the meta data information may include any information about the content or related to the content.

In the embodiment of FIG. 1, it has been illustrated that the plurality-of-items-of-content metadata information database 102 is external to the computing device 100. However, the disclosure is not limited thereto, and as such, the plurality-of-items-of-content metadata information database 102 may be part of the computing device 100 or present inside the computing device 100.

In an embodiment of the disclosure, the user-specific content viewing history database 101 and the plurality-of-items-of-content metadata information database 102 may be present in a server. For example, the user-specific content viewing history database 101 and the plurality-of-items-of-content metadata information database 102 may be located or stored in a server

The computing device 100 may generate a feature vector 103 for a user and feature vectors 104 for a plurality of respective items of content, by using content viewing history information about the user obtained from the user-specific content viewing history database 101 and metadata information about the plurality of items of content obtained from the plurality-of-items-of-content metadata information database 102. For example, the computing device 100 may generate a feature vector 103 for the user based on the content viewing history information related to the user obtained from the user-specific content viewing history database 101 and metadata information related to the plurality of items of content obtained from the plurality-of-items-of-content metadata information database 102. Also, the computing device 100 may generate feature vectors 104 for the plurality of respective items of content based on the content viewing history information related to the user obtained from the user-specific content viewing history database 101 and metadata information related to the plurality of items of content obtained from the plurality-of-items-of-content metadata information database 102.

In the embodiment of FIG. 1, the computing device 100 may generate feature vectors 103 for m users (where m is an integer) and generate feature vectors 104 for respective n items of content (where n is an integer).

According to an embodiment of the disclosure, the “feature vector for a user” may be defined by obtaining metadata information about at least one item of content viewed by a user based on a content viewing history of the user, selecting at least one feature from among a plurality of features included in the obtained metadata information, selecting one or more feature values (of the at least one selected feature, and determining an arrangement order of the selected feature values. For example, the selected feature may be a genre, and one or more feature value for the selected genre feature may be Action, Drama, Adventure, etc. However, the disclosure is not limited thereto, and as such, according to another embodiment, the selected feature may be different from the genre feature. For example, the features values of Action, Drama, Adventure, etc. may be assigned a numerical value. However, the disclosure is not limited thereto, and as such, the feature values may be defined in another manner.

In an embodiment of the disclosure, each element of a feature vector for a user may be a numerical value associated with the feature values according to the determined arrangement order among items of content viewed by the user.

In an embodiment of the disclosure, each element of the feature vector for a user may be obtained by listing, according to the determined arrangement order, a number of items of content whose genre is Action, a number of items of content whose genre is Drama, etc. among the items of content viewed by the user.

After a vector (vector space) is defined, the computing device 100 may generate a feature vector for a user by embedding, in the defined vector, a feature value of metadata information about at least one item of content viewed by the user.

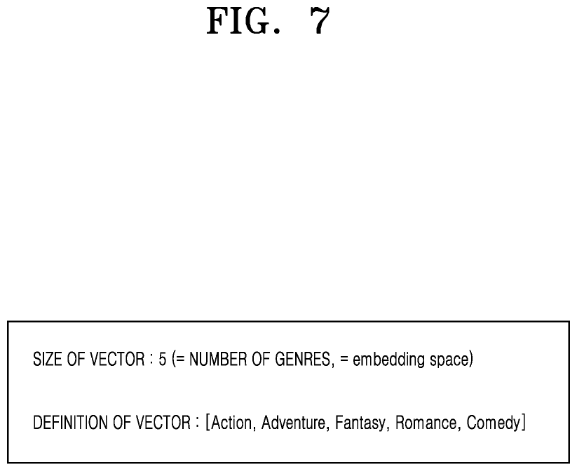

According to an embodiment of the disclosure, the “embedding” may refer to a process of converting whether there is a feature value corresponding to each element of a vector defined based on metadata information about content or how many of each feature value is present, into numbers that may be understood by a machine. that is, the “embedding” may refer to a process of generating each element of a pre-defined vector. A detailed description thereof will be provided below with reference to FIGS. 7, 9A, 9B, and 10.

According to an embodiment of the disclosure, the “vector space” or “embedding space” may refer to a space in which generated vectors may be represented.

For example, the computing device 100 may select a genre that is one feature of the metadata information about content, and may define a vector including Action, Adventure, Fantasy, Romance, and Comedy, among feature values for the genre. For example, the computing device 100 may define the vector including, in an order, Action, Adventure, Fantasy, Romance, and Comedy, among feature values for the genre. However, the disclosure is not limited thereto, and as such, according to another embodiment, the order of the feature values may be different.

According to an embodiment of the disclosure, the “size of a vector” may refer to the number of feature values included in the definition of a vector among feature values for at least one selected feature. In the example case above, because the vector is defined to include five feature values (i.e., Action, Adventure, Fantasy, Romance, and Comedy) for the genre, the size of the feature vector for the genre may be 5.

In an embodiment of the disclosure, the size of a vector may refer to the dimensionality of the vector.

According to an embodiment of the disclosure, a “feature vector for each item of content” may be defined by selecting at least one of a plurality of features included in metadata information about each of a plurality of items of content, selecting one or more feature values of the at least one selected feature, and determining an arrangement order of the selected feature values.

In an embodiment of the disclosure, each element of a feature vector for each item of content may represent whether there is a feature value according to an arrangement order determined for each item of content.

In an embodiment of the disclosure, each element of a feature vector for one item of content may be obtained by listing the content under one of the feature values, such as Action, Drama, and Romance based on a genre of the content, according to the determined arrangement order of feature values.

The computing device 100 may generate a feature vector for each of a plurality of items of content by embedding, in a defined vector, a feature value of metadata information about each of the plurality of items of content.

According to an embodiment of the disclosure, the “feature vector for each item of content” may have the same definition as the “feature vector for a user”. By embedding the “feature vector for each item of content” and the “feature vector for a user” in the same vector space, the computing device 100 may directly and easily compare the “feature vector for each item of content” and the “feature vector for a user” with one another.

The feature vectors 104 for respective items of content may be present for n items of content, respectively. For example, n items of content may include n feature vectors 104. For example, a first item of content may include a first feature vector, a second item of content may include a second feature vector, a third item of content may include a third feature vector, and a fourth item of content may include a fourth feature vector. However, the disclosure is not limited thereto, and as such, the number of content and the number of feature vector may be different than four.

The computing device 100 may compare the feature vector 103 for one user with the feature vectors 104 for the n items of content. For example, the computing device 100 may compare the feature vector 103 for one user with the feature vectors 104 for the respective n items of content.

The computing device 100 may calculate a similarity between the feature vector 103 for one user and each of the feature vectors 104 for the respective n items of content.

In an embodiment of the disclosure, a similarity between a vector and another vector may refer to spatial proximity, that is, a distance, between two vectors in a vector space. For example, the feature vector 103 for the user and a first feature vector for the first item of the content may have a first distance in the vector space and the feature vector 103 for the user and a second feature vector for the second item of the content may have a second distance in the vector space. In a case in which the first distance is smaller than the second distance, the computing device 100 may determine the first feature vector of the first item of the content to be more similar to the feature vector 103 of the user than the second feature vector of the second item of the content.

In the embodiment of FIG. 1, the similarity between the feature vector 103 for the user and each of the feature vectors 104 for the respective n items of content may be calculated using an algorithm called cosine similarity.

However, a method of calculating the similarity between the vector and the other vector is not limited to the cosine similarity. As such, according to another embodiment, the similarity between the feature vector 103 for the user and each of the feature vectors 104 for the respective n items of content may be calculated using various algorithms such as Jaccard similarity.

The computing device 100 may recommend content having the highest calculated similarity score to the user. In an embodiment of the disclosure, content having the highest similarity score may be a feature vector for content that is closest to the feature vector 103 for the user, among the feature vectors 104 for the respective n items of content.

In an embodiment of the disclosure, the computing device 100 may recommend a certain number of items of content to the user in descending order of the calculated similarity score. For example, the computing device 100 may recommend five items of content to the user in descending order of the calculated similarity score. However, the disclosure is not limited thereto, and as such, the computing device 100 may recommend more than five items of content or less than five items of content.

The computing device 100 may store a similarity score calculated between each of the m users and each of the n items of content (106). In an embodiment of the disclosure, the stored information may be periodically updated. However, the disclosure is not limited thereto, and as such, according to another embodiment, the stored information may be updated in a different manner. For example, the stored information may be updated upon a certain condition being met.

In an example case in which content is recommended using a related art artificial intelligence technology, results of low usability may be derived until a sufficient amount of viewing history data of a corresponding user is collected to learn about content preferences of the corresponding user.

On the other hand, according to an embodiment of the disclosure, even when there is only one history of content viewed by the user, the computing device 100 according to the disclosure may have higher accuracy of recommending content than a method of recommending content using related art artificial intelligence technology.

According to an embodiment of the disclosure, the computing device 100 may use relatively fewer resources than a related art artificial intelligence system. That is, according to an example embodiment of the disclosure, the computing device 100 provides for a technical improvement of reducing the use of computer resources, such as processing and/or memory resources. For example, the computing device 100 not use a graphics processor unit (GPU) or a server, and thus may use relatively fewer resources than a related art artificial intelligence system.

In addition, the computing device 100 according to the disclosure may adjust the direction of content recommendation by adjusting the manner in which the features of the metadata information is utilized. For example, the computing device 100 according to the disclosure may easily adjust the direction of content recommendation, by using which features of the metadata information to select, how many features to select, whether to assign equal weights to selected features, which feature value of at least one selected feature to be included in a vector, whether to assign equal weights to selected feature values, or the like.

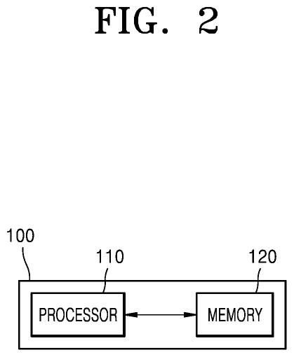

FIG. 2 is a block diagram of a configuration of a computing device according to an embodiment of the disclosure.

Referring to FIG. 2, the computing device 100 may include a processor 110 and a memory 120.

The memory 120 may store programs for processing and controlling the processor 110. Also, the memory 120 may store data input to the computing device 100 or output from the computing device 100.

The memory 120 may include at least one of an internal memory or an external memory (not shown). The memory 120 may store control history information, current environment information, and state information.

The memory 120 may include at least one type of storage medium among a flash memory-type memory, a hard disk-type memory, a multimedia card micro-type memory, a card-type memory (e.g., a secure digital (SD) or extreme digital (xD) memory), random access memory (RAM), static random access memory (SRAM), read-only memory (ROM), electrically erasable programmable ROM (EEPROM), programmable ROM (PROM), magnetic memory, a magnetic disk, or an optical disk.

The internal memory may include, for example, at least one of a volatile memory (e.g., dynamic RAM (DRAM), static RAM (SRAM), or synchronous dynamic RAM (SDRAM)), a nonvolatile memory (e.g., one-time programmable ROM (OTPROM), PROM, erasable and programmable ROM (EPROM), EEPROM, mask ROM, or flash ROM), a hard disk drive (HDD), or a solid state drive (SSD).

According to an embodiment of the disclosure, the processor 110 may load a command or data received from at least one of the nonvolatile memory or another component into the volatile memory and process the command or data. Also, the processor 110 may store data received or generated from another component in the nonvolatile memory.

The external memory may include, for example, at least one of a compact flash (CF) memory, an SD memory, a micro-SD memory, a mini-SD memory, an xD memory, or a memory stick.

The memory 120 may store one or more instructions executable by the processor 110.

In an embodiment of the disclosure, the memory 120 may store various types of information input through an input/output circuit.

In an embodiment of the disclosure, the memory 120 may store instructions to control the processor to obtain pieces of metadata information about a plurality of items of content and content viewing history information about a user, define a feature vector for at least one feature among the pieces of metadata information, generate a feature vector for the user by matching metadata information about at least one item of content viewed by the user to the defined feature vector based on the content viewing history information about the user, generate a feature vector for each of the plurality of items of content by matching metadata information about each of the plurality of items of content to the defined feature vector, and recommend at least one item of content to the user based on a similarity by comparing the feature vector for the user with each of the feature vectors for the plurality of items of content.

The processor 110 may execute an operation system (OS) and various applications stored in the memory 120 when there is a user input or a preset and stored condition is satisfied.

The processor 110 may include RAM that stores signals or data input from outside of the computing device 100 or is used as a storage area corresponding to various operations performed by the computing device 100, and ROM that stores control programs for controlling the computing device 100.

The processor 110 may include a single core, a dual core, a triple core, a quadruple core, and a core of a multiple thereof. Also, the processor 110 may include a plurality of processors. For example, the processor 110 may be implemented as a main processor and a sub-processor that operates in a sleep mode.

The processor 110 may include at least one of a central processing unit (CPU), a GPU, or a video processing unit (VPU). Alternatively, according to an embodiment of the disclosure, the processor 110 may be implemented in the form of a system on chip (SoC) in which at least one of a CPU, a GPU, or a VPU is integrated.

The processor 110 may control various components of the computing device 100 by executing the one or more instructions stored in the memory 120.

In an embodiment of the disclosure, the processor 110 may obtain pieces of metadata information about a plurality of items of content and may obtain content viewing history information about a user.

In an embodiment of the disclosure, the processor 110 may define a feature vector for at least one feature among the pieces of metadata information.

In an embodiment of the disclosure, the processor 110 may generate a feature vector for the user by matching metadata information about at least one item of content viewed by the user to the defined feature vector based on the content viewing history information about the user.

In an embodiment of the disclosure, the processor 110 may generate a feature vector for each of the plurality of items of content by matching metadata information about each of the plurality of items of content to the defined feature vector.

In an embodiment of the disclosure, the processor 110 may recommend at least one item of content to the user based on a similarity by comparing the feature vector for the user with each of the feature vectors for the plurality of items of content.

In an embodiment of the disclosure, the processor 110 may determine at least one feature to be used for content recommendation among the pieces of metadata information and define a feature vector for the determined at least one feature. The processor 110 may determine the at least one feature to be used for content recommendation based on a user input or based on a setting configuration. For example, the determination by the processor 110 may be performed based on a manual input form a user or based on an automatic setting.

In an embodiment of the disclosure, the processor 110 may define a feature vector having a size of K by extracting, from among the pieces of metadata information, K feature values with a high frequency for the at least one feature. In this case, the value K may be determined by referring to the number of feature values in which the frequency of at least one feature appearing in the plurality of items of content is greater than or equal to a threshold value. For example, K may be a integer.

In an embodiment of the disclosure, the processor 110 may define a feature vector for at least one feature by assigning a weight to at least one feature value for the at least one feature among the pieces of metadata information.

In an embodiment of the disclosure, the processor 110 may generate a feature vector for the user by determining an element of a vector for the feature value based on the number of occurrences of each feature value of at least one feature, among pieces of metadata information about each of the at least one item of content viewed by the user. A detailed description thereof will be provided below. The at least one item of content viewed by the user may include the same content.

In an embodiment of the disclosure, the processor 110 may recommend at least one item of content to the user in order of high similarity by comparing the feature vector for the user with the feature vector for each of the plurality of items of content. The similarity may refer to a degree of proximity between a feature vector for a user and a feature vector for each of a plurality of items of content in a vector space.

In an embodiment of the disclosure, the processor 110 may define a feature vector for a plurality of features among the pieces of metadata information. The feature vector may include feature values of a plurality of features as elements.

In an embodiment of the disclosure, the processor 110 may define a plurality of feature vectors for a plurality of features among the pieces of metadata information, generate a plurality of feature vectors for the user by matching the metadata information about at least one item of content viewed by the user to the plurality of defined feature vectors based on the content viewing history information about the user, generate a plurality of feature vectors for a plurality of respective items of content by matching metadata information about the plurality of respective items of content to the plurality of defined feature vectors, and recommend at least one item of content to the user based on a similarity by comparing a sum of the plurality of feature vectors for the user with a sum of the plurality of feature vectors for the plurality of respective items of content.

In addition, the block diagram of the computing device 100 shown in FIG. 2 is a block diagram for an embodiment of the disclosure. Each component of the block diagram may be integrated, added, or omitted according to specifications of the computing device 100 that is actually implemented. That is, two or more components may be combined into one component, or one component may be subdivided into two or more components as needed. In addition, functions performed by each block are for describing embodiments of the disclosure, and specific operations or devices thereof do not limit the scope of the disclosure.

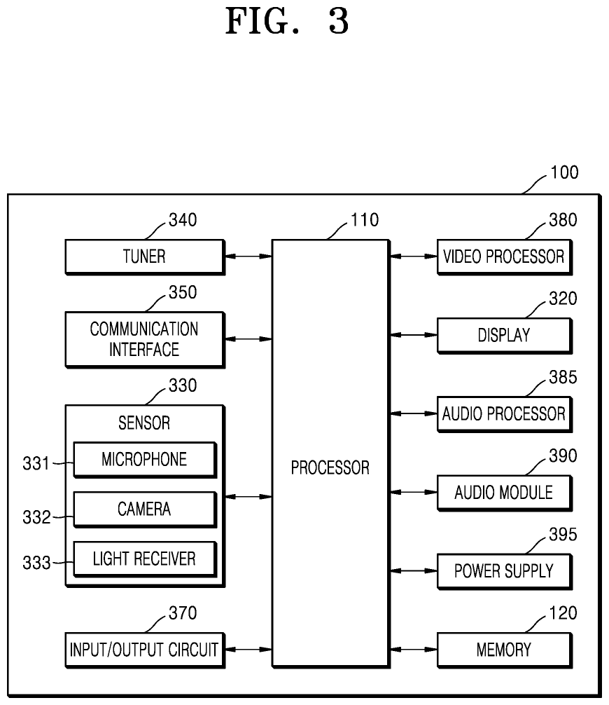

FIG. 3 is a block diagram of a detailed configuration of a computing device according to an embodiment of the disclosure.

The computing device 100 of FIG. 3 may be an embodiment of the computing device 100 described above with reference to FIGS. 1 and 2. For example, the computing device 100 of FIG. 3 may be a display device such as a smart TV.

Referring to FIG. 3, the computing device 100 may include a tuner 340, a processor 110, a display 320, a communication interface 350, a sensor 330, an input/output circuit 370, a video processor 380, an audio processor 385, an audio module 390, a memory 120, and a power supply 395.

The processor 110 of FIG. 3 corresponds to the processor 110 of FIG. 2, and the memory 120 of FIG. 3 corresponds to the memory 120 of FIG. 2. Therefore, the same description that has already been provided above will not be provided herein.

According to an embodiment of the disclosure, the communication interface 350 may include a Wi-Fi module, a Bluetooth module, an infrared communication module, a wireless communication module, a local area network (LAN) module, an Ethernet module, or a wired communication module. In this case, each communication module may be implemented in the form of at least one hardware chip.

The Wi-Fi module and the Bluetooth module perform communication using a Wi-Fi method and a Bluetooth method, respectively. When the Wi-Fi module or the Bluetooth module is used, various types of connection information such as a service set identifier (SSID) and a session key may be transmitted and received first, a communication connection may be established using the connection information, and then various types of information may be transmitted and received. The wireless communication module may include at least one communication chip for performing communication according to various wireless communication standards, such as Zigbee, 3^{rd} generation (3G), 3^{rd} generation partnership project (3GPP), long term evolution (LTE), LTE-advanced (LTE-A), 4^{th} generation (4G), and 5^{th} generation (5G).

According to an embodiment of the disclosure, the communication interface 350 may receive a user input from an external device.

According to an embodiment of the disclosure, the tuner 340 may tune and select only a frequency of a channel that is to be received by the computing device 100 from among many radio wave components, through amplification, mixing, resonance, etc. of a broadcast signal received in a wired or wireless manner. The broadcast signal includes audio, video, and additional information (e.g., an electronic program guide (EPG)).

The tuner 340 may receive broadcast signals from various sources such as terrestrial broadcasting, cable broadcasting, satellite broadcasting, Internet broadcasting, etc. The tuner 340 may receive broadcast signals from sources such as analog broadcasting, digital broadcasting, etc.

The sensor 330 may detect a user around the computing device 100 and may include at least one of a microphone 331, a camera 332, or a light receiver 333.

The microphone 331 receives a speech uttered by the user. The microphone 331 may convert the received speech into an electrical signal and output the electrical signal to the processor 110. The microphone 331 may use various noise cancellation algorithms to cancel noise occurring during reception of an external sound signal.

The camera 332 may obtain an image frame such as a still image or a moving image. An image captured through an image sensor may be processed by the processor 110 or a separate image processor.

The image frame processed by the camera 332 may be stored in the memory 120 or transmitted to the outside through the communication interface 350. Two or more cameras 332 may be included according to a configuration of the computing device 100.

The light receiver 333 receives an optical signal (including a control signal) received from an external remote-control device. The light receiver 333 may receive an optical signal corresponding to a user input (e.g., touching, pressing, a touch gesture, a speech, or a motion) from the remote-control device. A control signal may be extracted from the received optical signal under control by the processor 110. For example, the light receiver 333 may receive a control signal corresponding to a channel up/down button for channel switching from the remote-control device.

FIG. 3 illustrates that the sensor 330 includes the microphone 331, the camera 332, and the light receiver 333, but is not limited thereto. The sensor 330 may include at least one of a magnetic sensor, an acceleration sensor, a temperature/humidity sensor, an infrared sensor, a gyroscope sensor, a position sensor (e.g., a global positioning system (GPS)), a barometric pressure sensor, a proximity sensor, a red-green-blue (RGB) sensor, an illuminance sensor, a radar sensor, a lidar sensor, or a Wi-Fi signal receiver, but is not limited thereto. A function of each sensor may be intuitively inferred by one of ordinary skill in the art based on a name of the sensor, and thus, a detailed description thereof will not be provided herein.

FIG. 3 illustrates that the sensor 330 is provided in the computing device 100 itself, but is not limited thereto. The sensor 330 may be provided in a control device that is located independently of the computing device 100 such as a remote controller and communicates with the computing device 100.

When the sensor 330 is provided in the control device of the computing device 100, the control device may digitize information detected by the sensor 330 and transmit the information to the computing device 100. The control device may communicate with the computing device 100 using short-range communication including infrared rays, Wi-Fi, or Bluetooth.

The input/output circuit 370 may receive video (e.g., a moving image, etc.), audio (e.g., a speech, music, etc.), and additional information (e.g., an EPG, etc.) from the outside of the computing device 100, under the control by the processor 110. The input/output circuit 370 may include at least one of a high-definition multimedia interface (HDMI) port, a mobile high-definition link (MHL) port, a universal serial bus (USB) port, a display port (DP), a thunderbolt port, a video graphics array (VGA) port, an RGB port, a D-subminiature (D-SUB) port, a digital visual interface (DVI) port, a component jack, or a PC port.

The video processor 380 processes video data received by the computing device 100. The video processor 380 may perform various types of image processing, such as decoding, scaling, noise cancellation, frame rate conversion, and resolution conversion, on the video data.

The display 320 may generate a driving signal by converting an image signal, a data signal, an on-screen display (OSD) signal, a control signal, etc. processed by the processor 110. The display 320 may be implemented as a plasma display panel (PDP), a liquid crystal display (LCD), an organic light-emitting diode (OLED) display, a flexible display, or the like, and may also be implemented as a three-dimensional (3D) display. Also, the display 320 may be configured as a touch screen to be used as an input device other than an output device.

The display 320 may output various types of content input through a communication interface or the input/output circuit 370 or output an image stored in the memory 120. Also, the display 320 may output, on a screen, information input by a user through the input/output circuit 370.

The display 320 may include a display panel. The display panel may be an LCD panel or a panel including various types of light-emitting bodies, such as an LED, an OLED, and a cold cathode fluorescent lamp (CCFL). Also, the display panel may include not only a flat display device but also a curved display device including a screen having a curvature or a flexible display device having an adjustable curvature. The display panel may also include a 3D display or an electrophoretic display.

An output resolution of the display panel may include, for example, high definition (HD), full HD (FHD), ultra-HD (UHD), or a resolution higher than UHD.

In the embodiment of FIG. 3, it has been illustrated that the computing device 100 includes the display 320, but it not limited thereto. The computing device 100 may be connected to a separate display device including a display through wired/wireless communication and configured to transmit a video/audio signal to the display device.

The audio processor 385 processes audio data. The audio processor 385 may perform various types of processing, such as decoding, amplification, and noise cancellation, on the audio data. Moreover, the audio processor 385 may include a plurality of audio processing modules to process audio corresponding to a plurality of items of content.

The audio module 390 outputs audio included in a broadcast signal received through the tuner 340 under the control by the processor 110. The audio module 390 may output audio (e.g., a speech or sound) input through the communication interface 350 or the input/output circuit 370. Also, the audio module 390 may output audio stored in the memory 120 under the control by the processor 110. The audio module 390 may include at least one of a speaker, a headphone output terminal, or a Sony/Phillips digital interface (S/PDIF) output terminal.

The power supply 395 supplies power input from an external power source to the internal components of the computing device 100, under the control by the processor 110. The power supply 395 may also supply power output from one or more batteries located in the computing device 100 to the internal components thereof, under the control by the processor 110.

The memory 120 may store various types of data, programs, or applications for driving and controlling the computing device 100, under the control by the processor 110. The memory 120 may include a broadcast reception module, a channel control module, a volume control module, a communication control module, a speech recognition module, a motion recognition module, a light reception module, a display control module, an audio control module, an external input control module, a power control module, a power control module of an external device connected wirelessly (e.g., Bluetooth), a speech database (DB), or a motion database (DB), which are not shown in the drawings. The modules and the databases of the memory 120 may be implemented in the form of software to perform, in the computing device 100, a broadcast reception control function, a channel control function, a volume control function, a communication control function, a speech recognition function, a motion recognition function, a light reception control function, a display control function, an audio control function, an external input control function, a power control function, or a power control function of an external device connected wirelessly (e.g., Bluetooth). The processor 110 may perform respective functions by using the software stored in the memory 120.

In addition, the block diagram of the computing device 100 shown in FIG. 3 is a block diagram for an embodiment of the disclosure. Each component of the block diagram may be integrated, added, or omitted according to specifications of the computing device 100 that is actually implemented. That is, two or more components may be combined into one component, or one component may be subdivided into two or more components as needed. In addition, functions performed by respective blocks are for describing embodiments of the disclosure, and specific operations or devices thereof do not limit the scope of the disclosure.

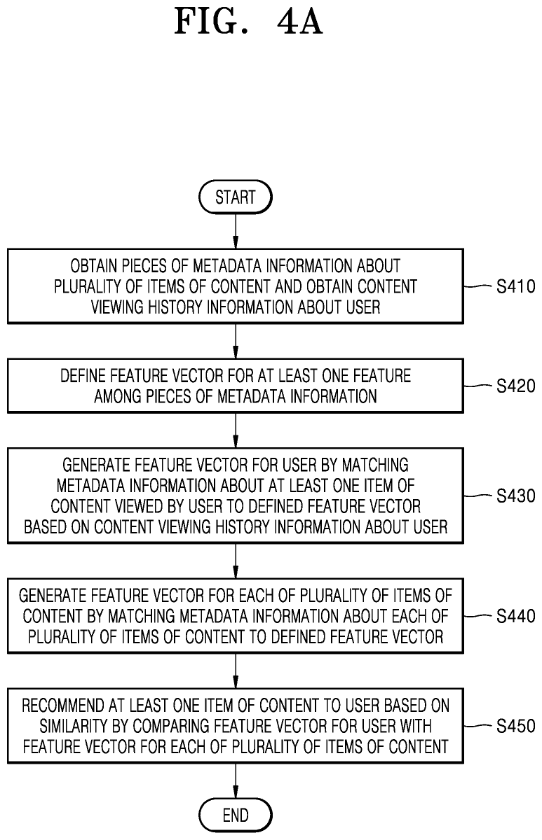

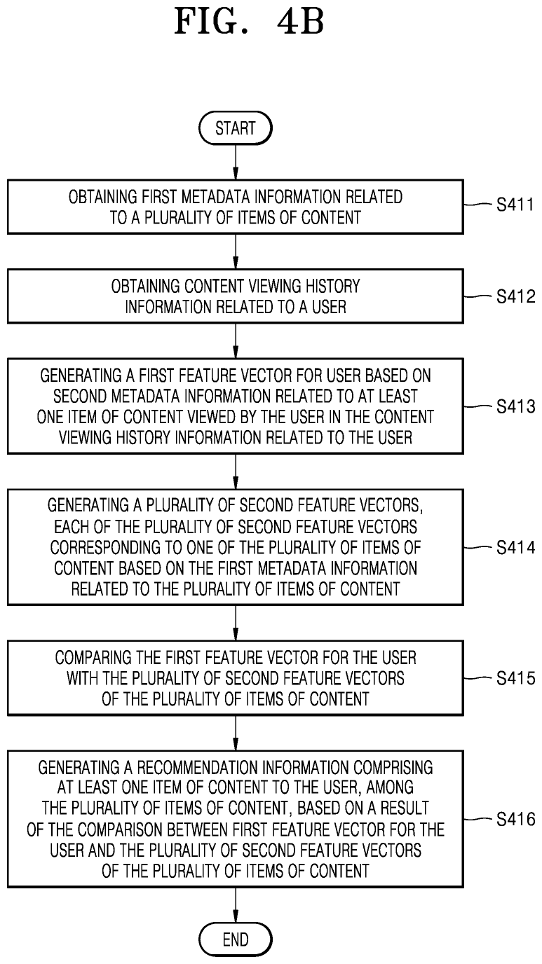

FIG. 4A is a flowchart illustrating an operating method of a computing device according to an embodiment of the disclosure.

Referring to FIG. 4A, in operation S410, the method may include obtaining pieces of metadata information about a plurality of items of content and content viewing history information about a user. For example, the computing device 100 may obtain pieces of metadata information about a plurality of items of content and content viewing history information about a user.

In an embodiment of the disclosure, the content viewing history information about the user may be information about content viewed by the user within a certain period of time. The certain period of time may be manually set by the user or automatically set by a system.

In an embodiment of the disclosure, the certain period of time may refer to a whole period of time after the user starts viewing content. In an embodiment of the disclosure, the certain period of time may refer to a period within 3 years or within 1 year from the present.

In an embodiment of the disclosure, the content viewing history information about the user may include a title, viewing date and time, etc. of the content.

In an embodiment of the disclosure, when the same content is viewed a plurality of times, the content may be duplicated and included in the content viewing history information about the user as many times as the number of times the user has viewed the content.

In operation S420, the method may include defining a feature vector for at least one feature among the pieces of metadata information. For example, the computing device 100 may define a feature vector for at least one feature among the pieces of metadata information.

In an embodiment of the disclosure, the computing device 100 may define a feature vector for a genre among a plurality of pieces of metadata information. The computing device 100 may define a feature vector including genre types, such as Action, Adventure, Fantasy, Romance, and Comedy, as feature values.

The computing device 100 may select a feature value to be included in the definition of the feature vector according to a certain criterion, from among the feature values for the genre.

For example, the computing device 100 may select Action, Adventure, Fantasy, Romance, and Comedy, for which the user has viewed a certain number of times or more, as feature values to be included in the definition of the feature vector, from among the feature values for the genre, including Action, Adventure, Fantasy, Romance, Comedy, Horror, Noir, Drama, Mystery, Thriller, etc. When a feature value for which the user has viewed too few times is selected as a feature value to be included in the definition of the feature vector, the feature value may be meaningless or disturbing noise in the selection of content to be recommended.

In an embodiment of the disclosure, the computing device 100 may analyze the frequency of a feature value included in a vector and periodically remove, from the definition of the vector, a feature value that may generate noise. In this case, the dimensionality of the vector may be reduced.

In an embodiment of the disclosure, the computing device 100 may analyze the frequency of the feature value included in the feature vector and periodically add, to the definition of the vector, a feature value important for determining content preferences of the user. In this case, the dimensionality of the vector may be expanded.

In an embodiment of the disclosure, the computing device 100 may improve the accuracy of content recommendation by using dimensionality reduction or dimensionality expansion of the vector.

In an embodiment of the disclosure, the computing device 100 may define a feature vector having a size of K by extracting, from among the pieces of metadata information, K feature values with a high frequency for the at least one feature. In an embodiment of the disclosure, K may be determined by referring to the number of feature values in which the frequency of the at least one feature appearing in the plurality of items of content is greater than or equal to a threshold value.

In an embodiment of the disclosure, the computing device 100 may identify that a viewing frequency of the user for the Action, Adventure, Fantasy, Romance, and Comedy genres, among various genre types, is greater than or equal to the threshold value. In this case, the computing device 100 may define a five-dimensional feature vector having a size of 5 including Action, Adventure, Fantasy, Romance, and Comedy.

In an embodiment of the disclosure, the defining of the feature vector for the at least one feature among the pieces of metadata information may include determining at least one feature among the pieces of metadata information.

The determination may be performed manually by a user input or automatically by setting. The computing device 100 may define a feature vector based on a feature value of the determined feature. For example, the computing device 100 may determine a genre among the pieces of metadata information, as a feature to be included in the feature vector.

According to an embodiment, a criterion for determining content to be recommended may be the feature of the metadata information being defined as a feature vector. For example, in an example case in which a feature vector for a genre is defined, content to be recommended may be determined based on content of a genre that the user has viewed many times. For example, in an example case in which a feature vector for a director is defined, content to be recommended may be determined based on content of a director that the user has viewed many times.

In an embodiment of the disclosure, the computing device 100 may define a feature vector for a plurality of features among the pieces of metadata information. In an example case in which the feature vector is defined for the plurality of features, user content may be recommended according to various criteria.

In an embodiment of the disclosure, the computing device 100 may define a feature vector for a genre and actor/actress among the pieces of metadata information.

In an embodiment of the disclosure, the computing device 100 may define a feature vector for a genre, director, and actor/actress among the pieces of metadata information.

The number of features that the computing device 100 includes to define the feature vector may not be limited.

In operation S430, the method may include generating a feature vector for the user by matching metadata information about at least one item of content viewed by the user to the defined feature vector, based on the content viewing history information about the user. For example, the computing device 100 may generate a feature vector for the user by matching metadata information about at least one item of content viewed by the user to the defined feature vector, based on the content viewing history information about the user.

In an embodiment of the disclosure, the computing device 100 may obtain metadata information about the at least one item of content viewed by the user based on the content viewing history information about the user.

In an embodiment of the disclosure, the computing device 100 may obtain metadata information about the at least one item of content viewed by the user from the pieces of metadata information about the plurality of items of content obtained in operation S410.

In an embodiment of the disclosure, the computing device 100 may obtain metadata information about the at least one item of content viewed by the user from an external device, such as the plurality-of-items-of-content metadata information database 102 of FIG. 2.

The computing device 100 may generate a feature vector for the user by matching the obtained metadata information to the defined feature vector.

In an embodiment of the disclosure, the computing device 100 may generate a feature vector for the user by summing up the number of times the user has viewed content corresponding to respective feature values included in the defined feature vector.

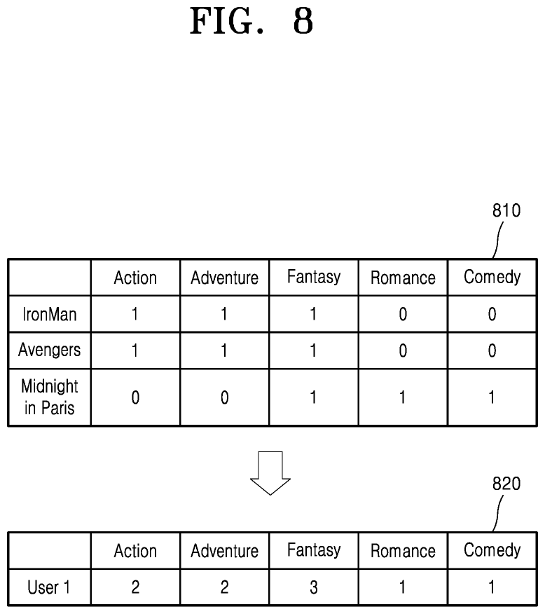

A detailed description of operation S430 will be provided below with reference to FIGS. 8, 9A, and 10.

In operation S440, the method may include generating a feature vector for each of a plurality of items of content by matching metadata information about each of the plurality of items of content to the defined feature vector. For example, the computing device 100 may generate a feature vector for each of a plurality of items of content by matching metadata information about each of the plurality of items of content to the defined feature vector.

The computing device 100 may generate a feature vector for each of the plurality of items of content by matching metadata information obtained for each of the plurality of items of content to the defined feature vector.

The feature vector for each of the plurality of items of content is a vector defined identically to the feature vector for the user and thus may be generated in the same manner as the feature vector for the user. Accordingly, the feature vector for each of the plurality of items of content and the feature vector for the user may be directly compared with each other in the same vector space.

However, the feature vector for the user may be a vector obtained by summing up vectors for all respective items of content viewed by the user, and the feature vector for each of the plurality of items of content may be a vector generated for one item of content.

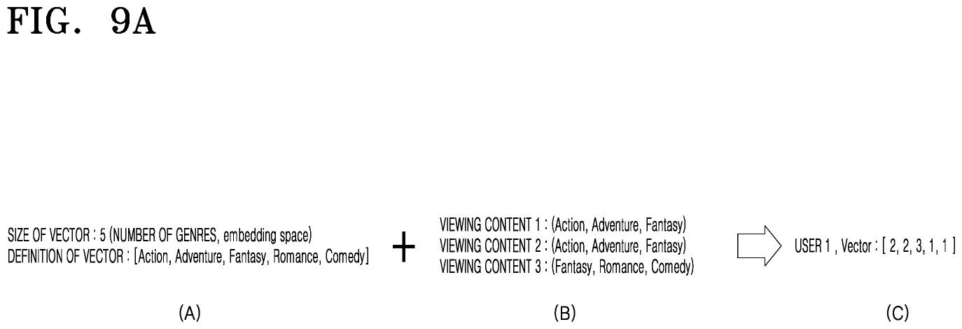

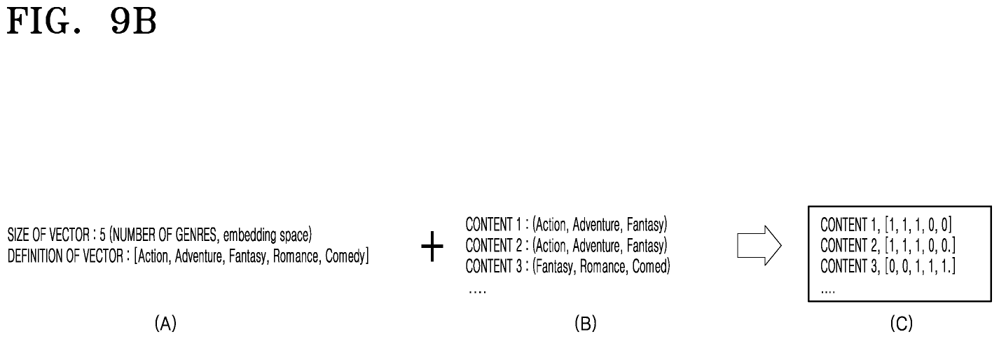

A detailed operation of operation S440 will be provided below with reference to FIGS. 8 and 9B.

In operation S450, the method may include recommending at least one item of content to the user based on a similarity by comparing the feature vector for the user with the feature vector for each of the plurality of items of content. For example, the computing device 100 may recommend at least one item of content to the user based on a similarity by comparing the feature vector for the user with the feature vector for each of the plurality of items of content.

In an embodiment of the disclosure, the computing device 100 may calculate a similarity between the feature vector for the user and the feature vector for each of the plurality of items of content by using an algorithm, such as cosine similarity or Jacard similarity.

In an embodiment of the disclosure, the similarity between the feature vector for the user and the feature vector for each of the plurality of items of content may be calculated by obtaining a distance between two coordinates in a vector space.

When a cosine similarity algorithm is used, the computing device 100 may obtain a normalized similarity score between 0 and 1.0.

A sequence of operations described in FIG. 4A is merely for an embodiment, and the computing device 100 may perform operations in a different sequence from the sequence shown in FIG. 4A.

In an embodiment of the disclosure, the computing device 100 may perform operation S420 prior to performing operation S410.

In an embodiment of the disclosure, the computing device 100 may perform operation S440 immediately prior to performing operation S430.

FIG. 4B is a flowchart illustrating an operating method of a computing device according to an embodiment of the disclosure.

Referring to FIG. 4B, in operation S411, the method may include obtaining first metadata information related to a plurality of items of content.

In operation S412, the method may include obtaining content viewing history information related to a user.

In operation S413, the method may include generating a first feature vector for user based on second metadata information related to at least one item of content viewed by the user in the content viewing history information related to the user.

In operation S414, the method may include generating a plurality of second feature vectors, each of the plurality of second feature vectors corresponding to one of the plurality of items of content based on the first metadata information related to the plurality of items of content.

In operation S415, the method may include comparing the first feature vector for the user with the plurality of second feature vectors of the plurality of items of content.

In operation S416, the method may include generating a recommendation information comprising at least one item of content to the user, among the plurality of items of content, based on a result of the comparison between first feature vector for the user and the plurality of second feature vectors of the plurality of items of content.

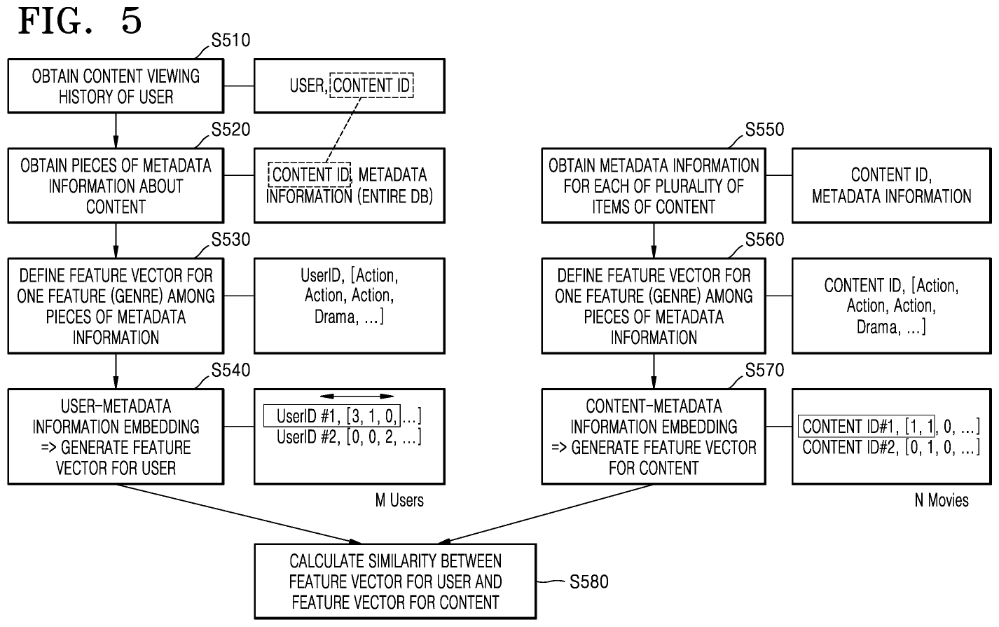

FIGS. 5 to 9B are diagrams for describing in detail, through an example, a process in which the computing device 100 generates a feature vector for a user and feature vectors for a plurality of respective items of content to determine content to be recommended.

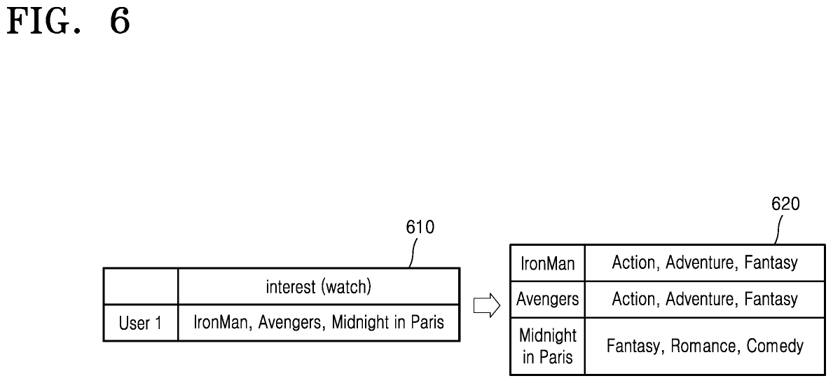

FIG. 5 is a flowchart illustrating an operating method of a computing device according to an embodiment of the disclosure. FIG. 6 is a diagram illustrating an example of a content viewing history of a user and metadata information about content viewed by the user, which are obtained by a computing device, according to an embodiment of the disclosure, FIG. 7 is a diagram for describing a process of defining a feature vector for a genre among pieces of metadata about content, according to an embodiment of the disclosure, and FIG. 8 is a diagram for obtaining a user feature for a genre among pieces of metadata about content included in a user viewing history to generate a feature vector for the user, according to an embodiment of the disclosure. FIG. 9A is a diagram illustrating an example of a method of generating a feature vector for a user, according to an embodiment of the disclosure, and FIG. 9B is a diagram illustrating an example of a method of generating a feature vector for each of a plurality of item of content, according to an embodiment of the disclosure.

Referring to FIG. 5, in operation S510, the method may include obtaining a content viewing history of a user. For example, the computing device 100 may obtain a content viewing history of a user.

Details of a method of obtaining the content viewing history of the user may be the same as those described above with reference to FIGS. 1 and 4.

In an embodiment of the disclosure, the content viewing history of the user may be obtained as a plurality of lists configured in the form of [user, content ID].

In an embodiment of the disclosure, the content viewing history of the user may be obtained in the form of listing content titles as shown in a table 610 of FIG. 6. In the embodiment of FIG. 6, content that a user 1 has viewed for a certain period of time may include Iron Man, the Avengers, and Midnight in Paris.

In operation S520, the method may include obtaining pieces of metadata information about content viewed by the user based on the content viewing history of the user. For example, the computing device 100 may obtain pieces of metadata information about content viewed by the user based on the content viewing history of the user.

In an embodiment of the disclosure, metadata may be obtained from pieces of metadata information obtained for a plurality of items of content in operation S550. In the embodiment of the disclosure, the computing device 100 may perform operation S550 prior to performing operation S520.

In an embodiment of the disclosure, the computing device 100 may obtain metadata information about the viewed content in the form of [content ID, metadata information].

In an embodiment of the disclosure, the computing device 100 may obtain metadata information about the viewed content in the form of a table 620 of FIG. 6. Metadata information may include information about at least one feature to be used for content recommendation. In an example embodiment, the metadata information may include only information about at least one feature to be used for content recommendation. For example, the obtaining of the pieces of metadata information about the viewed content (S520) may include determining at least one feature to be used for content recommendation. In the table 620 of FIG. 6, the computing device 100 may have selected a “genre” as a feature to be used for content recommendation from among a plurality of pieces of metadata information. In this case, the computing device 100 may obtain only information about the “genre” from among the plurality of pieces of metadata information. However, the disclosure is not limited thereto, and as such, according to another embodiment, tow features may be selected to be used for content recommendation.

In an embodiment of the disclosure, the metadata information may include not only information about at least one feature to be used for content recommendation, but all pieces of metadata information.

In the table 620 of FIG. 6, among pieces of metadata information for the content, Iron Man, Action, Adventure, and Fantasy may have been obtained as feature values for the feature genre, Action, Adventure, and Fantasy may have been obtained as feature values for the content, the Avengers, and Fantasy, Romance, and Comedy may have been obtained as feature values for the content, Midnight in Paris.

In operation S530, the method may include defining a feature vector for one feature, for example, a genre, among the pieces of metadata information. For example, the computing device 100 may define a feature vector for one feature, for example, a genre, among the pieces of metadata information.

In an embodiment of the disclosure, the vector may be defined in the form of a user ID, [Action, Adventure, Fantasy Romance, Comedy].

According to an embodiment illustrated in FIG. 7, the computing device 100 may define a vector having a size of 5, and the vector may include feature values of five genres: Action, Adventure, Fantasy, Romance, and Comedy.

The size of a vector may refer to an embedding space or the number of feature values of a genre used to define the vector.

In an embodiment of the disclosure, the computing device 100 may define a vector by further including feature values other than Action, Adventure, Fantasy, Romance, and Comedy among genres under which the content falls. In this case, the number of feature values is not limited. However, as described above, according to an embodiment, the computing device 100 may define a vector to include a feature value that may have a significant effect on generation of a recommendation result.

The feature value that may have a significant effect on generation of a recommendation result may indicate a feature value for which a user input, such as a feature value to be specifically reflected, is received or a feature value with a relatively high viewing frequency in the content viewing history of the user.

In an embodiment of the disclosure, the computing device 100 may define a feature vector by receiving, from the user, an input of a feature or feature value required to define the feature vector. In this case, content preferred at each moment, which is different from statistically identifiable preferences of the user, may be recommended according to the mood of the user.

In operation S540, the method may include generating a feature vector for the user. For example, the computing device 100 may generate a feature vector for the user.

The computing device 100 may generate a feature vector for the user by matching metadata information about at least one item of content viewed by the user to the feature vector defined in operation S530, based on the content viewing history information about the user.

According to an embodiment illustrated in FIG. 8, the computing device 100 may match the metadata information about the at least one item of content viewed by the user to the feature vector defined in operation S530, based on the content viewing history information about the user.

In the embodiment of FIG. 8, the computing device 100 may obtain metadata information for each of Iron Man, the Avengers, and Midnight, which are items of content viewed by the user. The computing device 100 may represent, by “0” and “1”, whether the content corresponds to a feature value of the feature vector defined in operation S530, as shown in a table 810.

According to the metadata information, because a genre of the content “Iron Man” corresponds to Action, Adventure, and Fantasy, the computing device 100 may generate a vector in which, among feature values included in the definition of the vector, elements corresponding to Action, Adventure, and Fantasy are represented by “1”, and elements corresponding to other remaining feature values are represented by “0”. As a result, a vector generated for Iron Man may be [1, 1, 1, 0, 0].

According to the metadata information, because a genre of the content “the Avengers” corresponds to Action, Adventure, and Fantasy, the computing device 100 may represent, among the feature values included in the definition of the vector, elements corresponding to Action, Adventure, and Fantasy by “1” and elements corresponding to other remaining feature values by “0”. As a result, a vector generated for the Avengers may be [1, 1, 1, 0, 0].

According to the metadata information, because a genre of the content “Midnight in Paris” corresponds to Fantasy, Romance, and Comedy, the computing device 100 may represent, among the feature values included in the definition of the vector, elements corresponding to Fantasy, Romance, and Comedy by “1” and elements corresponding to other remaining feature values by “0”. Accordingly, a vector generated for Midnight in Paris may be [0, 0, 1, 1, 1].

The computing device 100 may generate a feature vector for the user by summing up the vectors generated for Iron Man, the Avengers, and Midnight in Paris. Accordingly, each element of the generated feature vector for the user may indicate the number of times the user has viewed content matching a feature value corresponding to each element.

According to an embodiment illustrated in FIG. 8, as shown in a table 820, the computing device 100 sums up the number of times the user has viewed items of content corresponding to respective feature values included in the vector. Accordingly, the computing device 100 may identify that the user has viewed Action twice, Adventure twice, Fantasy three times, Romance once, and Comedy once.

The computing device 100 may generate a vector as shown in item (C) of FIG. 9A by using the aforementioned information. Each element of the vector may be the number of times the user has viewed content corresponding to a feature value defined in each position.

For example, because the vector described in item (C) of FIG. 9A is generated based on the definition of a vector as in item (A) of FIG. 9A, in a vector [2, 2, 3, 1, 1], the first element “2” may indicate the number of times the user has viewed content corresponding to the genre “Action” defined in the same position, and the second element “2” may indicate the number of times the user has viewed content corresponding to the genre “Adventure” defined in the same position.

For example, item (C) of FIG. 9A illustrates that a vector is generated for one user, but the disclosure is not limited thereto. As such, according to another embodiment, the computing device 100 may generate and store vectors for a plurality of users. For example, the computing device 100 may generate and store vectors for a plurality of users at once. In an example, the computing device 100 may generate and store vectors for a plurality of users simultaneously. In an example, the computing device 100 may generate and store vectors for a plurality of users at different times.

The computing device 100 may generate a feature vector for each item of content (operations S550-S570) separately from the generating of the feature vector for the user (operations S510-S540).

In an embodiment of the disclosure, the generating of the feature vector for the user (operations S510-S540) and the generating of the feature vector for each item of content (operations S550-S570) may be separate processes from each other. Accordingly, after the generating of the feature vector for the user (operations S510-S540) is completed, the generating of the feature vector for each item of content (operations S550-S570) does not necessarily need to be performed. The two processes may be performed concurrently, may be performed with a time difference therebetween, or may be performed in a different sequence, or some operations may be performed concurrently.

In operation S550, the method may include obtaining metadata information for each of a plurality of items of content. For example, the computing device 100 may obtain metadata information for each of a plurality of items of content. The obtaining of the metadata information for each of the plurality of items of content may be the same as that described above with reference to FIG. 1 or 4.

In an embodiment of the disclosure, the computing device 100 may obtain metadata information for each of the plurality of items of content in the form of [content ID, metadata information].

In operation S560, the method may include defining a feature vector for one feature. For example, the computing device 100 may define a feature vector for one feature, for example, a genre, among the pieces of metadata information.

Operation S560 may be the same as operation S530.

According to an embodiment, in an example case in which one of operation S560 or S530 is performed first, the computing device 100 may skip the other of operation S560 and 530.

In operation S570, the method may include generating a feature vector for each of the plurality of items of content. For example, the computing device 100 may generate a feature vector for each of the plurality of items of content.

The computing device 100 may generate a feature vector for each of the plurality of items of content by matching metadata information about each of the plurality of items of content to the feature vector defined in operation S530 or S560.

The computing device 100 may generate vectors as shown in item (C) of FIG. 9B by matching the metadata information about each of the plurality of items of content to the feature vector defined in operation S530 or S560. In this case, each element of a vector may be a value representing, by “0” or “1”, whether each item of content corresponds to a feature value of metadata information defined in each position.

For example, because a vector described in item (C) of FIG. 9B is generated based on the definition of a vector as in item (A) of FIG. 9B, in a vector [1, 1, 1, 0, 0] for content 1, the first element “1” may indicate that the content 1 corresponds to the genre “Action” defined in the same position, and the second element “1” may indicate that the content 1 corresponds to the genre “Adventure” defined in the same position.

In the same manner, it may be seen that content 2 corresponds to the Action, Adventure, and Fantasy genres, and content 3 corresponds to the Fantasy, Romance, and Comedy genres.

The computing device 100 may generate and store vectors for all items of content in the same manner.

In the embodiment of FIG. 5, the computing device 100 may generate a feature vector for M users and generate a feature vector for each of N items of content.

In operation S580, the method may include calculating a similarity by comparing a feature vector for one user among the M users with a feature vector for each of a plurality of items of content. For example, the computing device 100 may calculate a similarity by comparing a feature vector for one user among the M users with a feature vector for each of a plurality of items of content.

A method of calculating the similarity may be the same as the method described in operation S450 of FIG. 4A.

The computing device 100 may recommend at least one item of content to the user based on a calculated similarity score. For example, the calculated similarity score may be a similarity value representing a level or amount of similarity.

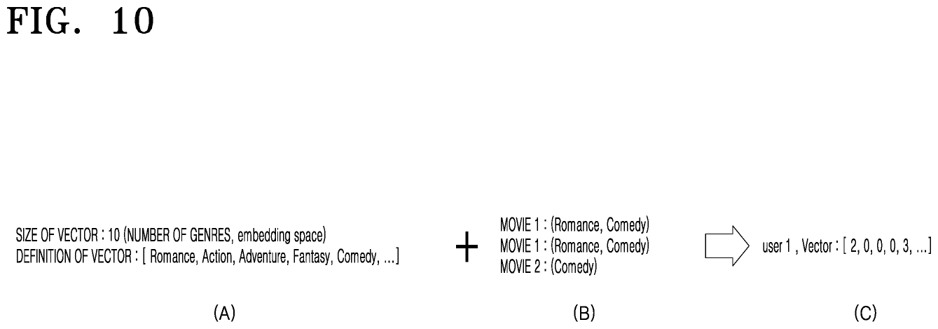

FIG. 10 is a diagram illustrating an example of a method of generating a feature vector for a user, according to an embodiment of the disclosure.

The computing device 100 may define a feature vector for one feature, for example, a genre, among pieces of metadata information shown in item (A).

In the embodiment of FIG. 10, a vector may be defined as [Romance, Action, Adventure, Fantasy, Romance, Comedy, . . . ].

In the embodiment of FIG. 10, the vector may be defined as a vector having a size of 10 including 10 feature values for a genre, such as Romance, Action, Adventure, Fantasy, and Comedy.

The size of a vector may refer to an embedding space or the number of genres used to define the vector.

According to content viewing history information about a user, content viewed by the user may be a movie 1 and a movie 2. The computing device 100 may identify that the user has viewed the movie 1 twice by referring to the content viewing history information about the user.

As described above, at least one item of content viewed by the user may include the same content.

In an embodiment of the disclosure, the computing device 100 may identify that a genre of the movie 1 is Romance and Comedy and a genre of the movie 2 is Comedy, by using metadata information about each of a plurality of items of content as shown in item (B).

In this case, the computing device 100 may generate a feature vector for the user as shown in item (C) by matching metadata information about the at least one item of content viewed by the user as shown in item (B) to the defined feature vector as shown in item (A) based on the content viewing history information about the user.

As in the embodiment of FIG. 8, the computing device 100 may match the metadata information about the at least one item of content viewed by the user to the defined feature vector based on the content viewing history information about the user.

As described in the embodiment of FIG. 8, the computing device 100 may represent, by “0” and “1”, whether each item of content viewed by the user corresponds to a feature value of a feature vector defined by obtaining the metadata information.

The computing device 100 may sum up the number of times the user has viewed content corresponding to respective feature values included in the vector.

The computing device 100 may generate a vector as shown in item (C) of FIG. 10 by using the summed number of times for respective feature values. In this case, each element of the vector may be the number of times the user has viewed content corresponding to a feature value defined in each position.

For example, because the vector described in item (C) of FIG. 10 is generated based on the definition of a vector as in item (A) of FIG. 10, in the generated vector [2, 0, 0, 0, 3, . . . ], the first element “1” may indicate the number of times the user has viewed content corresponding to the genre “Romance” defined in the same position, and the fifth element “3” may indicate the number of times the user has viewed content corresponding to the genre “Comedy” defined in the same position.

For example, item (C) of FIG. 10 illustrates that a vector is generated for one user, but the computing device 100 may generate and store vectors for a plurality of users.

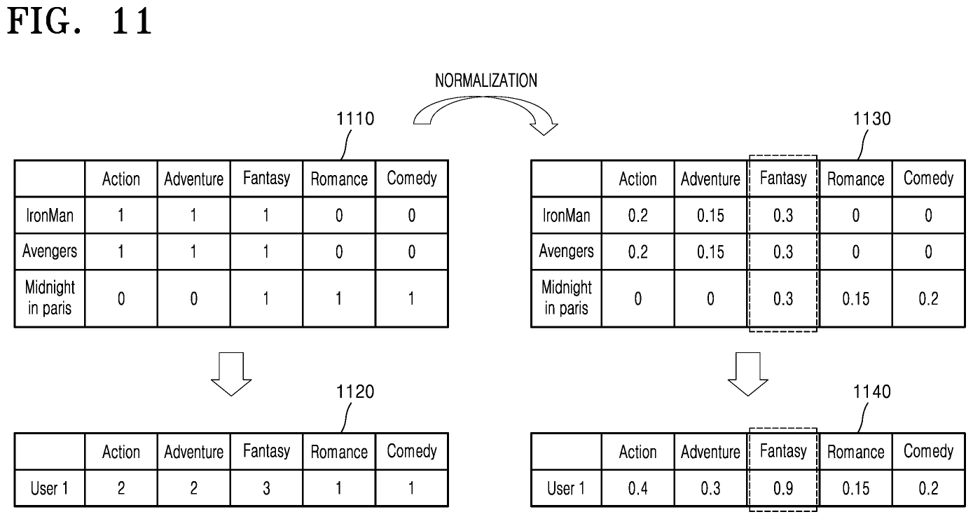

FIG. 11 is a diagram illustrating an example of a method of normalizing a user feature and assigning a weight to the user feature for a genre of content, according to an embodiment of the disclosure.

The computing device 100 may define a feature vector by assigning a weight to at least one feature selected from among pieces of metadata information or one or more feature values of the at least one selected feature.

The embodiment of FIG. 11 may be an embodiment in which weights are assigned to some of the one or more feature values of the at least one selected feature.

In FIG. 11, the at least one selected feature is a genre of content, and the computing device 100 includes Action, Adventure, Fantasy, Romance, and Comedy among feature values for the genre in the definition of the feature vector.

Tables 1110 and 1120 of FIG. 11 may correspond to the tables 810 and 820 of FIG. 8, respectively. A redundant description thereof will not be provided herein.

In an embodiment of the disclosure, the computing device 100 may generate the feature vector as shown in item (C) of FIG. 9A by assigning equal weights to Action, Adventure, Fantasy, Romance, and Comedy, which are feature values for the genre.

However, in the embodiment of FIG. 11, the computing device 100 may assign unequal weights to Action, Adventure, Fantasy, Romance, and Comedy, which are the feature values for the genre. The computing device 100 may easily adjust the direction of content recommendation by assigning unequal weights to the feature values.

In FIG. 11, the computing device 100 may convert “1” in the table 1110 to “0.2” in a table 1130 by normalizing elements, such that a sum of five elements represented by “0” or “1” in the table 1100 becomes 1.

When the size of a vector is 4, the computing device 100 may change “1” in the table 1110 to “0.25” in the table 1130, such that a sum of four elements becomes 1.

The computing device 100 may assign different weights to five feature values.

In the table 1130 of FIG. 11, the computing device 100 may normalize “1” in the table 1110 to 0.2 in the table 1130 without changing weights for Action and Comedy.

In contrast, for Adventure, the computing device 100 may reduce the weight and normalize “1” in the table 1110 to 0.15, instead of 0.2 in the table 1130.

Instead, for Fantasy, the computing device 100 may increase the weight and normalize “1” in the table 1110 to 0.3, instead of 0.2 in the table 1130.

For Romance, the computing device 100 may reduce the weight and normalize “1” in the table 1110 to 0.15, instead of 0.2 in the table 1130.

The computing device 100 may generate a vector as shown in a table 1140 by summing up values assigned to respective elements in the table 1130. The vector may be represented as [0.4, 0.3, 0.9, 0.15, 0.2].

By reducing weights for the Adventure and Romance genres and increasing a weight for the Fantasy genre as described above, the computing device 100 may recommend content in which an intention to prefer the Fantasy genre and relatively not prefer the Adventure and Romance genres is emphasized and reflected.

In an embodiment of the disclosure, the computing device 100 may generate an intentionally biased result in a feature value that is expected to be most preferred by the user, by assigning a weight to only one genre that the user has viewed the most.

The computing device 100 may adjust weights of feature values included in the definition of a feature vector by using various other methods.

In an embodiment of the disclosure, the computing device 100 may generate a result in which a normalization process is skipped and only weights are assigned. For example, when a weight of 1.5 is assigned to Fantasy, the computing device 100 may convert “1” in the table 1110 to “1.5” in the table 1130.

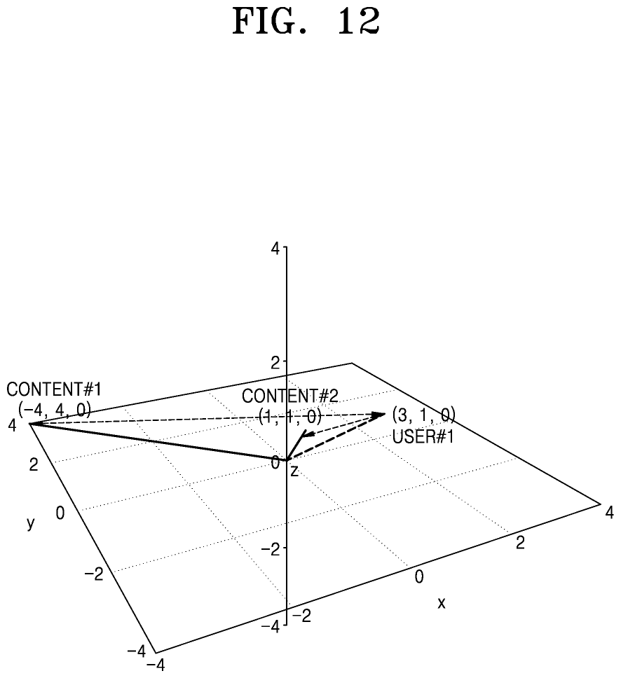

FIG. 12 is a diagram illustrating an example of a method of comparing a feature vector for a user with a feature vector for each item of content, according to an embodiment of the disclosure.

The computing device 100 may recommend at least one item of content to the user based on a similarity by comparing a feature vector for the user with a feature vectors for each of a plurality of items of content. In this case, the computing device 100 may calculate a similarity by comparing the feature vector for the user with the feature vector for each of the plurality of items of content.

The computing device 100 may display both the feature vector for the user and the feature vector for each of the plurality of items of content in the same vector space, by generating the feature vector for the user and the feature vector for each of the plurality of items of content according to the same definition of a vector.

The similarity may be calculated using a distance between two vectors in the same vector space.

The computing device 100 may determine that a similarity between the two vectors is higher as the distance between the two vectors decreases.

The embodiment of FIG. 12 may be an embodiment in which the computing device 100 recommends content by using a vector defined in three dimensions.

In an embodiment of the disclosure, coordinates of a feature vector USER #1 for a user 1 in the vector space may be (3, 1, 0). Also, among a plurality of items of content, coordinates of a feature vector content #1 for content 1 in the vector space may be (−4, 4, 0), and coordinates of a feature vector content #1 for content 2 in the vector space may be (1, 1, 0).

The aforementioned description of a method by which the computing device 100 calculates the distance between the two vectors will not be provided herein.

In the embodiment of FIG. 12, the computing device 100 may identify that a distance between the feature vector USER #1 for the user 1 and a feature vector content #2 for the content 2 is shorter than a distance between the feature vector USER #1 for the user 1 and the feature vector content #1 for the content 1.

Accordingly, the computing device 100 may preferentially recommend the content 2 to the user 1 over the content 1.

By comparing a distance between each of feature vectors content #1 to content #N for a plurality of items of content and the feature vector USER #1 for the user 1 in the same manner, the computing device 100 may recommend items of content to the user in order of short distance from the feature vector USER #1 for the user 1, among the plurality of items of content.

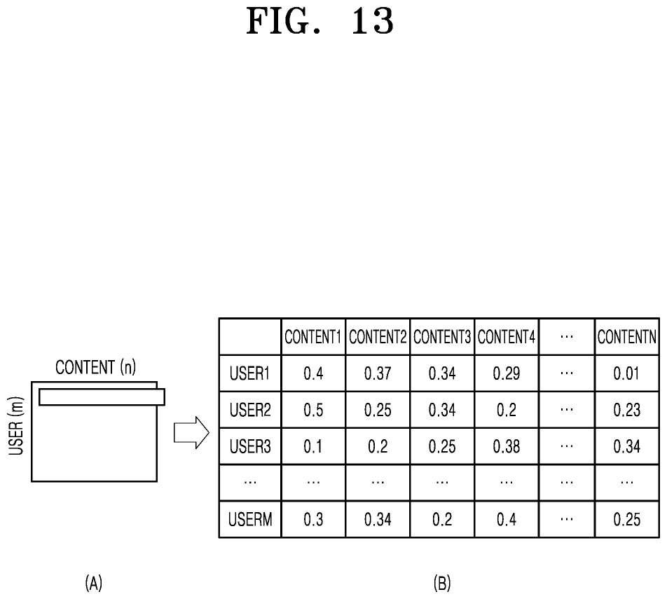

FIG. 13 is a diagram illustrating an example of a result of calculating a recommendation score for each item of content based on obtained content viewing histories of users, according to an embodiment of the disclosure.

The computing device 100 may calculate a similarity by comparing a feature vector for a user with a feature vector for each of a plurality of items of content. The calculated similarity may be expressed as a similarity score.

The computing device 100 may store a similarity score calculated between each of m users and each of n items of content as shown in item (A). A table of item (A) may be the same as a table 106 of FIG. 1.

A table of item (B) may be an example of similarity scores respectively calculated between the m users and the n items of content. The computing device 100 may store the similarity scores.

For example, for a user 1, the computing device 100 may calculate similarity scores of 0.4 for content 1, 0.37 for content 2, 0.34 for content 3, 0.29 for content 4, . . . , 0.01 for content N.

The computing device 100 may first recommend, to the user 1, the content 1 having the highest similarity score for the user 1, among N items of content. The computing device 100 may recommend other items of content to the user 1 in order of high similarity scores, among the N items of content.

In an embodiment of the disclosure, the similarity scores may be normalized scores.

In the same manner, the computing device 100 may first recommend, to a user 2, the content 1 having the highest similarity score for the user 2, among the N items of content.

In the same manner, the computing device 100 may first recommend, to a user 3, content 4 having the highest similarity score for the user 3, among the N items of content.

Because each user has a different content viewing history, different items of content may be recommended.

In an embodiment of the disclosure, the computing device 100 may store recommendation scores for respective items of content as shown in the table of item (B), such that content may be recommended whenever the user wishes.

In an embodiment of the disclosure, the computing device 100 may periodically update recommendation scores for respective items of content for respective users as shown in the table of item (B), by periodically performing the process as shown in FIG. 4A. An update cycle may vary by month, week, or day.

In an embodiment of the disclosure, the computing device 100 may perform the process as shown in FIG. 4A in real time at the moment when content needs to be recommended to the user.

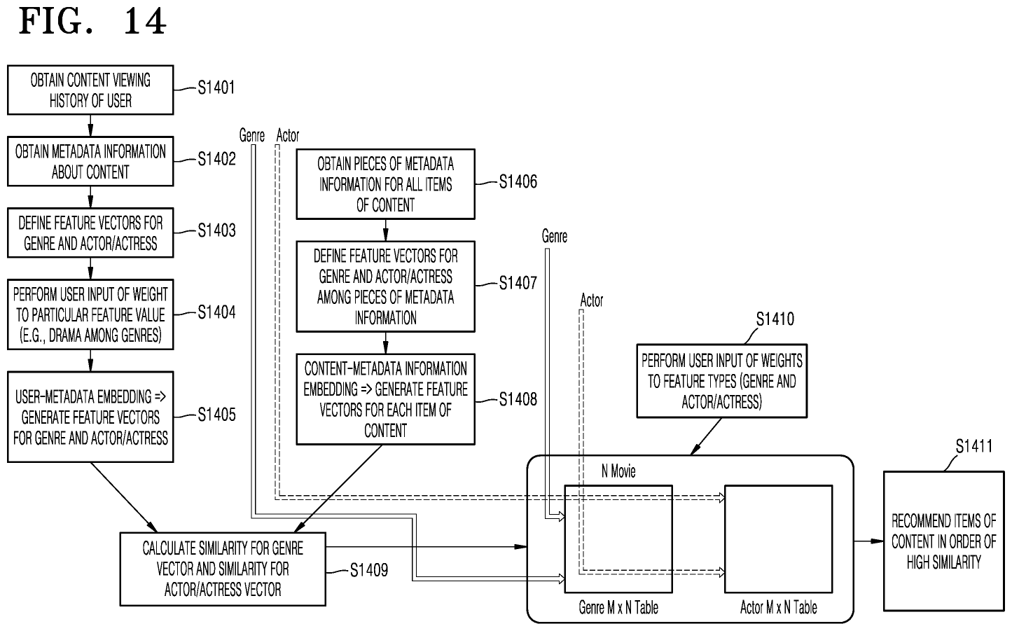

FIG. 14 is a flowchart illustrating an operating method of a computing device for recommending content based on two features of content metadata information, according to an embodiment of the disclosure.

The computing device 100 may define a plurality of feature vectors for a plurality of features among pieces of metadata information.

The computing device 100 may generate a plurality of feature vectors for a user by matching metadata information about at least one item of content viewed by the user to a plurality of defined feature vectors based on content viewing history information about the user, generate a plurality of feature vectors for a plurality of respective items of content by matching metadata information about the plurality of respective items of content to the plurality of defined feature vectors, and recommend at least one item of content to the user based on a similarity by comparing a sum of the plurality of feature vectors for the user with a sum of the plurality of feature vectors for the plurality of respective items of content.

In operation S1401, the method may include obtaining a content viewing history of a user. For example, the computing device 100 may obtain a content viewing history of a user.

In operation S1402, the method may include obtaining pieces of metadata information about content viewed by the user based on the content viewing history of the user. The computing device 100 may obtain pieces of metadata information about content viewed by the user based on the content viewing history of the user.

The obtaining of the metadata information about the viewed content (S1402) may include determining at least one feature to be used for content recommendation. In FIG. 14, a “genre” and an “actor/actress” are selected as features to be used for content recommendation, from among a plurality of pieces of metadata information. In an embodiment of the disclosure, the computing device 100 may obtain only information about the “genre” and the “actor/actress” among the plurality of pieces of metadata information in operation S1402.

In operation S1403, the method may include defining feature vectors for two features, for example, the genre and the actor/actress, among the pieces of metadata information. The computing device 100 may define feature vectors for two features, for example, the genre and the actor/actress, among the pieces of metadata information.

The computing device 100 may define a feature vector for the genre and a feature vector for the actor/actress, respectively. In this case, the two feature vectors may be defined separately without affecting each other.

In operation S1404, the method may include setting weights for some or all of feature values for the genre or some or all of feature values for the genre. In an embodiment of the disclosure, the computing device 100 may set weights for some or all of feature values for the genre or some or all of feature values for the actor/actress (S1404). When weight setting is not required, this operation may be skipped. A description of the weight setting overlapping with those made with reference to FIG. 11 will not be repeated again.

The weights may be manually set by a user input or automatically set by the system.

In operation S1405, the method may include generating feature vectors for the user respectively for the genre and the actor/actress. The computing device 100 may generate feature vectors for the user respectively for the genre and the actor/actress.

A method by which the computing device 100 generates feature vectors for the user respectively for the genre and the actor/actress may be the same as the method of generating the feature vector for the user in operation S540 of FIG. 5.

The computing device 100 may generate two feature vectors for the user by matching metadata information about at least one item of content viewed by the user to the two feature vectors defined in operation S1403 based on the content viewing history information about the user.

The computing device 100 may generate feature vectors for each item of content (S1406-S1408) separately from the generating of the feature vectors for the user (S1401-S1405).

In an embodiment of the disclosure, the generating of the feature vectors for the user (S1401-S1405) and the generating of the feature vectors for each item of content (S1406-S1408) may be separate processes from each other. Accordingly, after the generating of the feature vectors for the user (S1401-S1405) is completed, the generating of the feature vectors for each item of content (S1406-S1408) does not necessarily need to be performed. The two processes may be performed concurrently, may be performed with a time difference therebetween, or may be performed in a different sequence, or some operations may be performed concurrently.

In operation S1406, the method may include obtaining pieces of metadata information for each of a plurality of items of content. The computing device 100 may obtain pieces of metadata information for each of a plurality of items of content.

In operation S1407, the method may include defining feature vectors for two features, for example, the genre and the actor/actress, among the pieces of metadata information. The computing device 100 may define feature vectors for two features, for example, the genre and the actor/actress, among the pieces of metadata information.

Operation S1407 may be the same as operation S1403.

When either operation S1407 or S1403 is performed first, the computing device 100 may skip the other operation.

In operation S1408, the method may include generating feature vectors for each of the plurality of items of content. The computing device 100 may generate feature vectors for each of the plurality of items of content.

The computing device 100 may generate feature vectors for the genre and feature vectors for the actor/actress for the plurality of respective items of content.

In operation S1409, the method may include calculating a similarity for the genre by comparing a feature vector for a genre of the content viewed by the user with a feature vector for the genre of each of the plurality of items of content, and calculating a similarity for the actor/actress by comparing a feature vector for an actor/actress of the content viewed by the user with a feature vector for the actor/actress for each of the plurality of items of content. For example, the computing device 100 may calculate a similarity for the genre by comparing a feature vector for a genre of the content viewed by the user with a feature vector for the genre of each of the plurality of items of content, and calculate a similarity for the actor/actress by comparing a feature vector for an actor/actress of the content viewed by the user with a feature vector for the actor/actress for each of the plurality of items of content.

In operation S1410, the method may include applying weights to feature types. In an embodiment of the disclosure, the computing device 100 may apply weights to feature types.

For example, among two feature types, genre and actor/actress, a weight may be set higher for the genre. In this case, the weights may be manually set by a user input or automatically set by the system. When weight setting is not required, this operation may be skipped.

In operation S1411, the method may include recommending items of content in order of high similarity. The computing device 100 may recommend items of content in order of high similarity. For example, the computing device 100 may generate recommendation information including one or more items of content for recommendation.

In an embodiment of the disclosure, the computing device 100 may sum up a similarity of a genre vector which the set weight is reflected and a similarity of an actor/actress vector in which the set weight is reflected. The computing device 100 may recommend items of content in order of high summed similarity.

With respect to FIG. 14, a description overlapping with those already provided in each operation of FIG. 5 will not be repeated again.

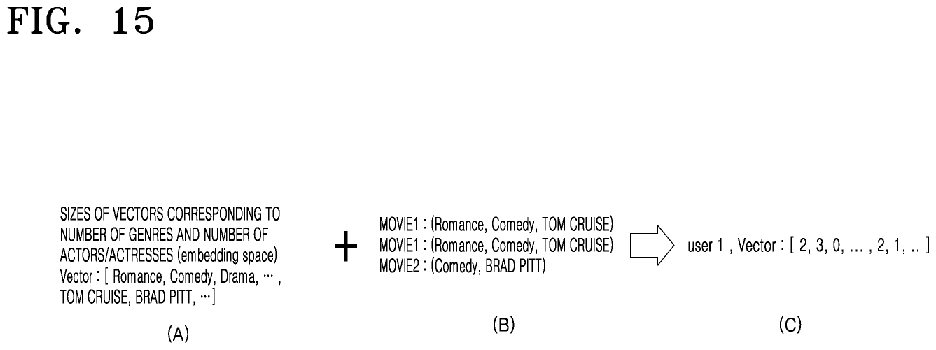

FIG. 15 is a diagram illustrating an example in which a computing device recommends content based on two features of content metadata information, according to an embodiment of the disclosure.

The computing device 100 may define a feature vector for a plurality of features among pieces of metadata information, and the feature vector may include feature values for the plurality of features as elements.

In FIG. 14, a plurality of feature vectors are defined for a plurality of features by including feature values of one feature in one feature vector. However, unlike FIG. 14, in the embodiment of FIG. 15, the computing device 100 may define a feature vector by including all feature values of a plurality of features in one feature vector.

For example, the computing device 100 may define a feature vector including feature values of two features, genre and actor/actress, in one vector.

In item (A) of FIG. 15, a vector may be defined by including a plurality of features, such as [Romance, Comedy, Drama, . . . , Tom Cruise, Brad Pitt, . . . ].

The computing device 100 may obtain pieces of metadata information about a movie 1, such as (Romance, Comedy, Tom Cruise), and obtain pieces of metadata information about a movie 2, such as (Comedy, Brad Pitt), among items of content viewed by a user. In the embodiment of FIG. 15, the user may have viewed the movie 1 twice.

In the same manner that the feature vector for the user is generated in FIGS. 9A and 10, the computing device 100 may represent, by “0” and “1”, whether obtained metadata information corresponds to a feature value of a defined feature vector, for each item of content viewed by the user.

In an embodiment of the disclosure, the computing device 100 may generate a vector for the movie 1, such as [1, 1, 0, . . . , 1, 0, . . . ], and generate a vector for the movie 2, such as [0, 1, 0, . . . , 0, 1, . . . ].

The computing device 100 may generate a feature vector for the user, such as [2, 3, 0, . . . , 2, 1, . . . ], which is a sum of vectors generated for respective items of content viewed by the user, by reflecting a content viewing history of the user who has viewed the movie 1 twice and the movie 2 once. In this case, the movie 1 has been viewed twice and thus may be summed twice.

When content is recommend by reflecting a plurality of features as described above, preferences of a user may be reflected in various aspects, and thus, the accuracy of content recommendation may increase.

For example, when content is recommended by reflecting both a preferred genre of the user and a preferred actor/actress of the user, the satisfaction of the user with recommended content may be higher than when content is recommended by reflecting only the preferred genre of the user.

The operating method of a computing device according to an embodiment of the disclosure may be implemented in the form of a computer-readable recording medium including instructions executable by a computer such as a program module executed by the computer. The computer-readable recording medium may be any available medium which is accessible by a computer, and may include a volatile or nonvolatile medium and a detachable or non-detachable medium. The computer-readable recording medium may include program commands, a data file, a data structure etc. alone or in combination. The program commands written to the computer-readable recording medium may be specifically designed and configured for the disclosure or may be well-known and available to one of ordinary skill in the art. Examples of the computer-readable recording medium include magnetic media such as hard disks, floppy disks, magnetic tapes, etc., optical media such as compact disc-ROMs (CD-ROMs), or digital versatile discs (DVDs), magneto-optical media such as floptical disks, and hardware devices specifically configured to store and execute program commands such as ROM, RAM, flash memories, etc. Examples of the program commands include high-level language code that can be executed by a computer by using an interpreter or the like as well as machine language codes generated by a compiler.

The above description of the disclosure is provided for illustration, and it will be understood by those of ordinary skill in the art that various changes in form and details may be readily made without departing from the technical spirit or essential features of the disclosure as defined by the following claims. Therefore, it will be understood that the embodiments of the disclosure should be considered in descriptive sense only and not for purposes of limitation. For example, each component described in a single type may be executed in a distributed manner, and components described distributed may also be executed in an integrated form.

What is claimed is:

1. An apparatus comprising:
a memory storing one or more instructions; and
at least one processor configured to execute the one or more instructions stored in the memory to:
obtain first metadata information related to a plurality of items of content;
obtain content viewing history information related to a user;
generate a first feature vector for the user based on second metadata information related to at least one item of content viewed by the user in the content viewing history information related to the user;
generate a plurality of second feature vectors, each of the plurality of second feature vectors corresponding to one of the plurality of items of content based on the first metadata information related to the plurality of items of content;
compare the first feature vector for the user with the plurality of second feature vectors of the plurality of items of content; and
generate a recommendation information comprising at least one item of content to the user, among the plurality of items of content, based on a result of the comparison between first feature vector for the user and the plurality of second feature vectors of the plurality of items of content.

2. The apparatus of claim 1, wherein the at least one processor is further configured to execute the one or more instructions to:
determine at least one feature information, among one or more feature information in the first metadata information and the second metadata information, and
generate the first feature vector and the plurality of second feature vectors based on the at least one feature information.

3. The apparatus of claim 2, wherein the at least one processor is further configured to execute the one or more instructions to:
generate the first feature vector and the plurality of second feature vectors, each having a size of K, by extracting, from the first metadata information and the second metadata information, K feature values corresponding to the at least one feature information.

4. The apparatus of claim 3, wherein K is determined by referring to a number of feature values in which a frequency of the at least one feature information in the plurality of items of content is greater than or equal to a threshold value.

5. The apparatus of claim 3, wherein the at least one processor is further configured to execute the one or more instructions to:
generate the first feature vector and the plurality of second feature vectors based on a weight assigned to at least one feature value, among the K feature values corresponding to the at least one feature information in the first metadata information and the second metadata information.

6. The apparatus of claim 2, wherein the at least one processor is further configured to execute the one or more instructions to:
generate the first feature vector for the user based on a number of occurrences of each feature value of the at least one feature information, in the second metadata information related to each of at least one item of content viewed by the user.

7. The apparatus of claim 1, wherein the at least one item of content viewed by the user comprises a first item identical to a second item.

8. The apparatus of claim 1, wherein the at least one processor is further configured to execute the one or more instructions to:
generate the recommendation information in order of high similarity to low similarity based on the result of the comparison,
wherein the similarity represents a degree of proximity between the first feature vector for the user and each of the plurality of second feature vectors in a vector space.

9. The apparatus of claim 1, wherein the at least one processor is further configured to execute the one or more instructions to:
define a feature vector information for each of a plurality of features in the first metadata information and the second metadata information,
wherein the feature vector information comprises feature values for each of the plurality of features as elements.

10. The apparatus of claim 1, wherein the at least one processor is further configured to execute the one or more instructions to:
define a plurality of feature vectors information for a plurality of features in the first metadata information and the second metadata information;
generate a plurality of first feature vectors for the user by matching pieces of the second metadata information related to the at least one item of content viewed by the user to the plurality of defined feature vectors;
generate a plurality of third feature vectors for each of the plurality of items of content by matching the first metadata information related to each of the plurality of items of content to the plurality of defined feature vectors; and
generate the recommendation information comprising the at least one item of content to the user based on a result of comparing a sum of the plurality of first feature vectors for the user with a sum of the plurality of third feature vectors for each of the plurality of items of content.

11. A method of operating an apparatus, the method comprising:
obtaining first metadata information related to a plurality of items of content;
obtaining content viewing history information related to a user;
generating a first feature vector for the user based on second metadata information related to at least one item of content viewed by the user in the content viewing history information related to the user;
generating a plurality of second feature vectors, each of the plurality of second feature vectors corresponding to one of the plurality of items of content based on the first metadata information related to the plurality of items of content;
comparing the first feature vector for the user with the plurality of second feature vectors of the plurality of items of content; and
generating a recommendation information comprising at least one item of content to the user, among the plurality of items of content, based on a result of the comparison between first feature vector for the user and the plurality of second feature vectors of the plurality of items of content.

12. The method of claim 11, further comprising:
determining at least one feature information, among one or more feature information in the first metadata information and the second metadata information; and
generating the first feature vector and the plurality of second feature vectors based on the at least one feature information.

13. The method of claim 12, further comprising:
generating the first feature vector and the plurality of second feature vectors, each having a size of K, by extracting, from of the first metadata information and the second metadata information, K feature values corresponding to the at least one feature information.

14. The method of claim 13, wherein the K is determined by referring to a number of feature values in which a frequency of the at least one feature information in the plurality of items of content is greater than or equal to a threshold value.

15. The method of claim 13, further comprising:
generating the first feature vector and the plurality of second feature vectors based on a weight assigned to at least one feature value, among the K feature values corresponding to the at least one feature information in the first metadata information and the second metadata information

16. The method of claim 12, wherein the generating of the first feature vector for the user comprises:
generating the first feature vector for the user based on a number of occurrences of each feature value of the at least one feature information, in the first metadata information related to each of the at least one item of content viewed by the user.

17. The method of claim 11, wherein the generating the recommendation information comprises:
generating the recommendation information in order of high similarity to low similarity based on the result of the comparison,
wherein the similarity represents a degree of proximity between the first feature vector for the user and each of the plurality of second feature vectors in a vector space.

18. The method of claim 11, further comprising:
defining a feature vector information for each of a plurality of features in the first metadata information and the second metadata information,
wherein the feature vector information comprises feature values for each of the plurality of features as elements.

19. The method of claim 11, further comprising:
define a plurality of feature vectors information for a plurality of features in the first metadata information and the second metadata information generating a plurality of first feature vectors for the user by matching pieces of the first metadata information related to the at least one item of content viewed by the user to the plurality of defined feature vectors;
generating a plurality of third feature vectors for each of the plurality of items of content by matching pieces of the second metadata information related to each of the plurality of items of content to the plurality of defined feature vectors; and
generating the recommendation information comprising the at least one item of content to the user based on a result of comparing a sum of the plurality of feature first vectors for the user with a sum of the plurality of third feature vectors for each of the plurality of items of content.

20. A non-transitory computer-readable recording medium having recorded thereon a program for executing an operation on a computer, the operation comprising:
obtaining first metadata information related to a plurality of items of content;
obtaining content viewing history information related to a user;
generating a first feature vector for the user based on second metadata information related to at least one item of content viewed by the user in the content viewing history information related to the user;
generating a plurality of second feature vectors, each of the plurality of second feature vectors corresponding to one of the plurality of items of content based on the first metadata information related to the plurality of items of content;
comparing the first feature vector for the user with the plurality of second feature vectors of the plurality of items of content; and
generating a recommendation information comprising at least one item of content to the user, among the plurality of items of content, based on a result of the comparison between first feature vector for the user and the plurality of second feature vectors of the plurality of items of content.
